(19) United States
(12) Patent Application Publication
(10) Pub. No.: US 2004/0165012 A1
(43) Pub. Date: Aug. 26, 2004

(54) Cascading menu with selectable offset

(75) Inventors: Brian David Nelson, Austin, TX (US); Michael William Panico, Austin, TX (US); Hypatia Rojas, Round Rock, TX (US)

Correspondence Address: Mark D. Simpson, Synnestvedt & Lechner LLP, 2600 Aramark Tower, 1101 Market Street, Philadelphia, PA, 19107-2950, US

(73) Assignee: International Business Machines Corp., Armonk, NY (US)

(21) Appl. No.: 10/371,037

(22) Filed: Feb. 20, 2003

(51) Int. Cl. G09G 5/00

(52) U.S. Cl. 345/828; 345/815

(57) ABSTRACT

A GUI is configured to give a user a selectable option to choose a preferred amount of offset for cascading menus. The user can manually input an offset of any value and in a preferred embodiment the offset is selectable from 1-100%, and presets can be made available from a drop-down menu (e.g., in 10% increments, i.e., 10%, 20%, 30%, etc.) for selection. This allows the user to minimize the need to move the mouse pointer horizontally to access a cascading menu and thus reduces the inadvertent selection of an incorrect menu item.

### FIELD OF THE INVENTION

This invention relates to personal computer systems and, more particularly, to a method, system, and computer program product for improving a graphical user interface (GUI) on a personal computer system and the use thereof.

### BACKGROUND OF THE INVENTION

In recent years, virtually all personal computers and workstations have adopted a graphical user interface (GUI) environment, which allows a user to manage the system and execute applications using a “point-and-click” method on objects shown on the computer display. The main GUI background is commonly referred to as the “desktop”, and these objects typically include graphic icons, which represent some software application or function, and windows, which divide the desktop into different areas on the display for different applications.

It is well known that with GUI systems, the computer system can be controlled using a pointing device such as a mouse. The pointing device controls the location of a pointer that appears on the screen of the computer's display device. Icons and windows may be manipulated using the mouse. In this way, underlying devices which the elements represent maybe controlled.

Typical GUI systems employ “dropdown” menus to give the user of the GUI additional control and functionality options. For example, when a cascade menu appears in the user's desktop on the screen, the user is presented with a first dropdown menu that typically includes a plurality of choices, each of the choices representing a basic function. FIG. 1 illustrates a typical dropdown menu structure found in most GUI's in use today. In FIG. 1, a dropdown menu 104 is displayed upon selection of the “Help” menu item 102 along the top of the window 100. Dropdown menu 104 in this example has several options for selection, including “tutorials” option 106, which includes a right arrow 108 next to the “tutorials” option 106.

The right arrow 108 is an indication that a sub-menu is available for the “tutorials” option 106, meaning that additional options exist under the heading “tutorials”. This is an example of what is known as a “cascading” dropdown menu, described below in connection with FIG. 2.

FIG. 2 illustrates the dropdown menu 104 of FIG. 1 after a user has clicked on the “tutorial” option 106. As can be seen in FIG. 2, a second dropdown menu 210 has appeared, giving the user several choices under the “tutorials” category. The dropdown menu 210 is a cascading dropdown menu since it derives or cascades from dropdown menu 104. To select one of the tutorials displayed in cascading dropdown menu 210, the user moves the mouse pointer to the right, to cover one of the tutorial selections in cascading dropdown menu 210, and then clicks on the desired selection.

For the purpose of the discussion of cascading menus herein, it is important to identify the relationship between a menu generating a cascade dropdown menu and the cascading dropdown menu itself. For ease of explanation, the menus are described in term so of generations, so that a “parent” menu describes a first level of menu, which spawns a “child” menu, which in turn spawns a “grandchild” menu, etc.

As shown in FIG. 2, a child menu in a prior art cascading menu system displays either to the right (typical as shown) or, if space is limited on the right side, to the left of the parent menu. In either case, there is essentially no overlap of the parent menu by its child menu. In other words, the child menu is “100% offset” with respect to its parent and this offset is not changeable by the user. With a 100% offset, the user is required to move the mouse pointer a significant distance in the horizontal direction just to reach the menu selections in the child menu. If there is more than one child menu available for the parent, many times this results in the user inadvertently selecting the wrong child menu; as the user moves the mouse pointer horizontally, it travels upwards or downwards (i.e., it does not travel in a straight line horizontally across the screen) as it traverses the horizontal distance. This problem can be particularly acute when the user has a handicap affecting manual dexterity because, for example, their hands may shake as they move the mouse.

Accordingly, it would be desirable to have a cascading menu system in which the need to move the mouse pointer horizontally to reach a cascading menu is reduced and/or minimized.

### SUMMARY OF THE INVENTION

In accordance with the present invention, a GUI is configured to give a user a selectable option to choose a preferred amount of offset for cascading menus. A default value of 100% offset could be set, which conforms with current systems where 100% offset is the only available setting. In accordance with the present invention, the user can manually input an offset of any value (e.g., from 1-100%), and presets available from a drop-down menu (e.g., in 10% increments, i.e., 10%, 20%, 30%, etc.) can be made available for selection. This allows the user to minimize the need to move the mouse pointer horizontally to access a cascading menu and thus reduces the inadvertent selection of an incorrect menu item.

### BRIEF DESCRIPTION OF THE DRAWINGS

FIG. 1 illustrates a typical prior art dropdown menu structure;

FIG. 2 illustrates the prior art dropdown menu of FIG. 1 after a user has clicked on a menu selection;

FIG. 3 illustrates a cascading menu system of the present invention;

FIG. 4 illustrates the display of the same cascading menu illustrated in FIG. 3, with the exception that, in FIG. 4, the user has set the “cascade offset” value to be approximately 50% (in the horizontal direction); and

FIG. 5 is a flowchart illustrating an example of the steps performed by a GUI configured in accordance with the present invention.

### DETAILED DESCRIPTION OF THE INVENTION

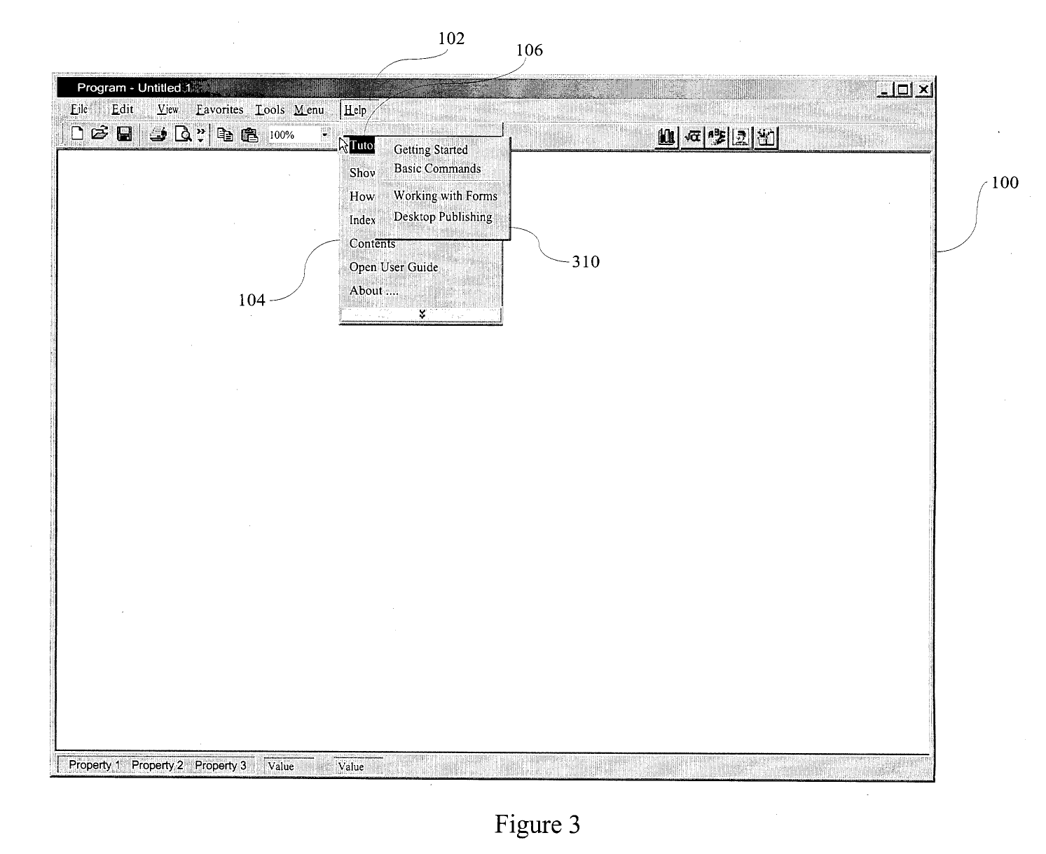

FIG. 3 illustrates a cascading menu system of the present invention. Referring to FIG. 3, a child menu 310 is shown overlapping the parent menu 104 from which it depends. In FIG. 3, the child menu 310 is offset by approximately 20%, that is, approximately 80% of the child menu 310 is covering the parent menu 104. This reduces significantly the amount of travel required of a mouse pointer to designate an item from the child menu.

The mouse pointer is configured to always be “on top”, i.e., it will always appear on the top layer. Thus, when the user places the pointer on a cascading selection (e.g., “tutorials”) and click the mouse to activate the cascading menu, the child menu will appear overlapping the parent by the selected amount, with the mouse pointer sitting directly on the child menu, or if the user (in this example) had the mouse pointer on the far left side of the parent menu when clicking the mouse, then immediately adjacent to the child menu in the 20% area not covered by the child. In either case, the distance to be traveled to get to the child is minimal to none.

The amount of overlap can be variable and selectable by the user, according to their preference and/or needs, by selection of an “offset value”. It is anticipated, for example, that this system could be used by persons suffering from a handicap that limits or reduces the mobility of their hands, and that reducing the amount of movement required will be of significant value to them. However, it is understood that the present invention will be useful for all GUI users.

The selection of the amount of offset (i.e., the offset value) can be performed using any known method for enabling a GUI user to select preferences for operation of the browser. For example, the user may be presented with a “preferences” option from a dropdown menu (e.g., from the “Tools” menu item along the top of window 100), which preference menu includes an option for selection of the offset amount (an offset value selection) for cascading menus. In a preferred embodiment, the user can be given the opportunity to manually set the offset value to any value from 1 to 100% and/or can be given a selection menu from which preset values (e.g., 10%, 20%, 30%, etc. can be selected. It is contemplated that situations might arise where a user might wish to have an offset value less than zero (negative offset, e.g., to move the cascading menu to the left of the parent menu illustrated in FIG. 3) or greater than 100% (e.g., to move the cascading menu further away to the right of the parent menu illustrated in FIG. 3) and such offset values are considered covered by the claims of the present invention. The method of selection is not considered novel; it is the ability to set the amount of offset that is considered a novel aspect of the present invention.

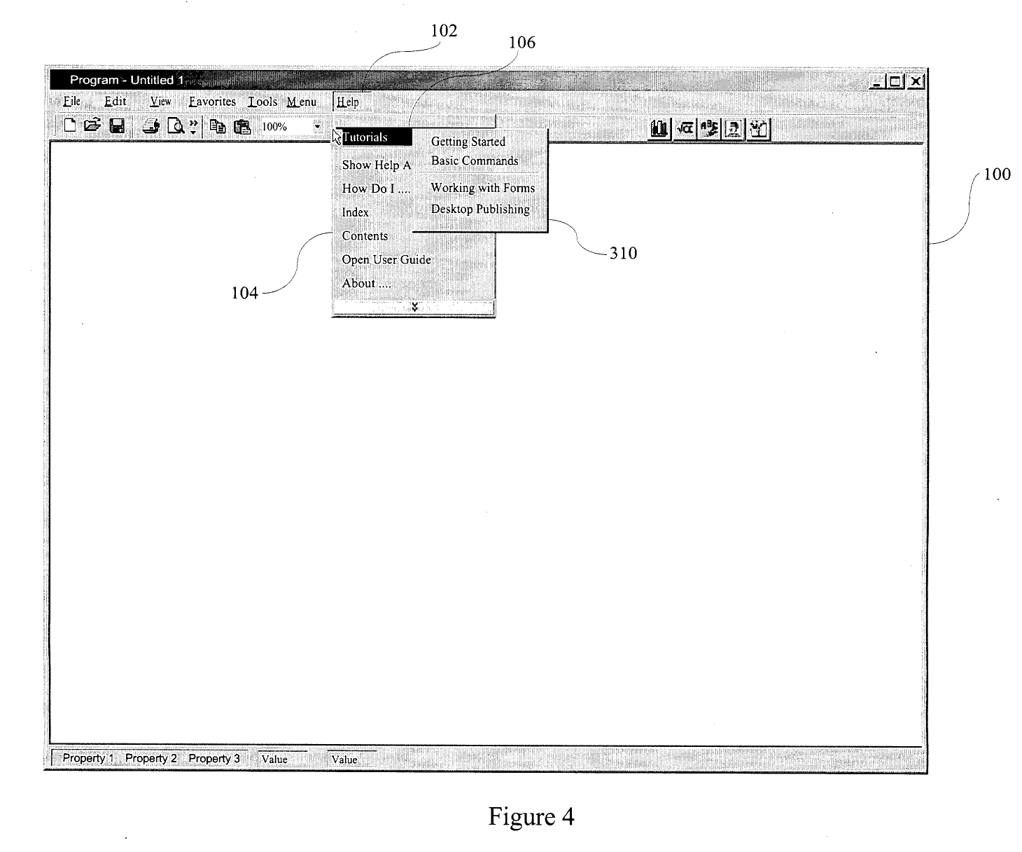

FIG. 4 illustrates the display of the same cascading menu illustrated in FIG. 3, with the exception that, in FIG. 4, the user has set the “cascade offset” value to be approximately 50% (in the horizontal direction). As can be seen in FIG. 4, child menu 310 now covers approximately 50% (in the horizontal direction) of the primary menu 104. This reduces the amount of travel in the horizontal direction required by the mouse user, although not to the extent illustrated in FIG. 3. As is clear, varying the offset percentage will change the horizontal offset of the cascading submenu 310.

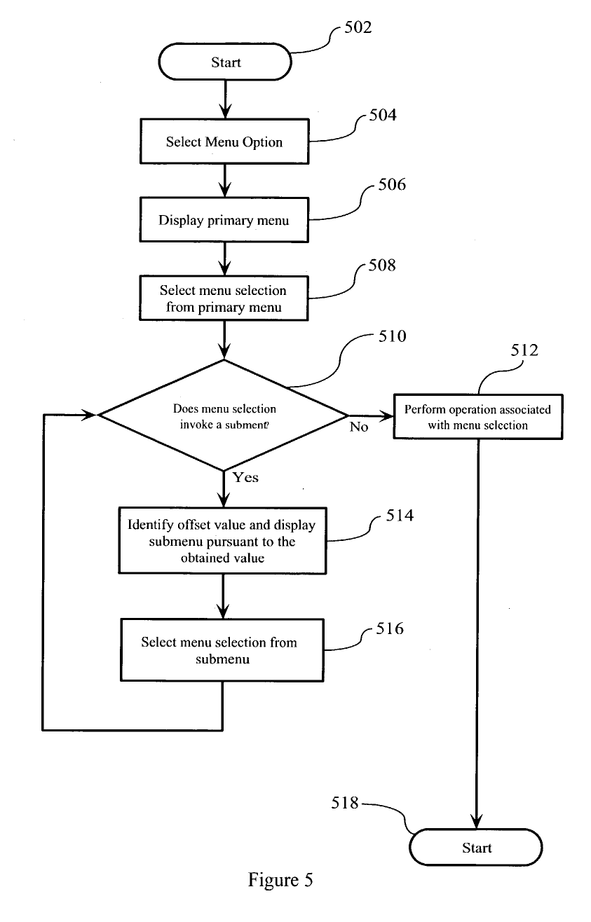

FIG. 5 is a flowchart illustrating the operation of a GUI configured in accordance with the present invention. At step 502, the GUI is started, and at step 504, the user selects a menu item. For example, the user may select the “Help” menu item 102 illustrated in, for example, FIG. 3. At step 506, as a result of the selection of the menu item, the GUI displays the parent menu in dropdown form as is well known. At step 508, the user uses the mouse to select a menu selection from the displayed parent menu.

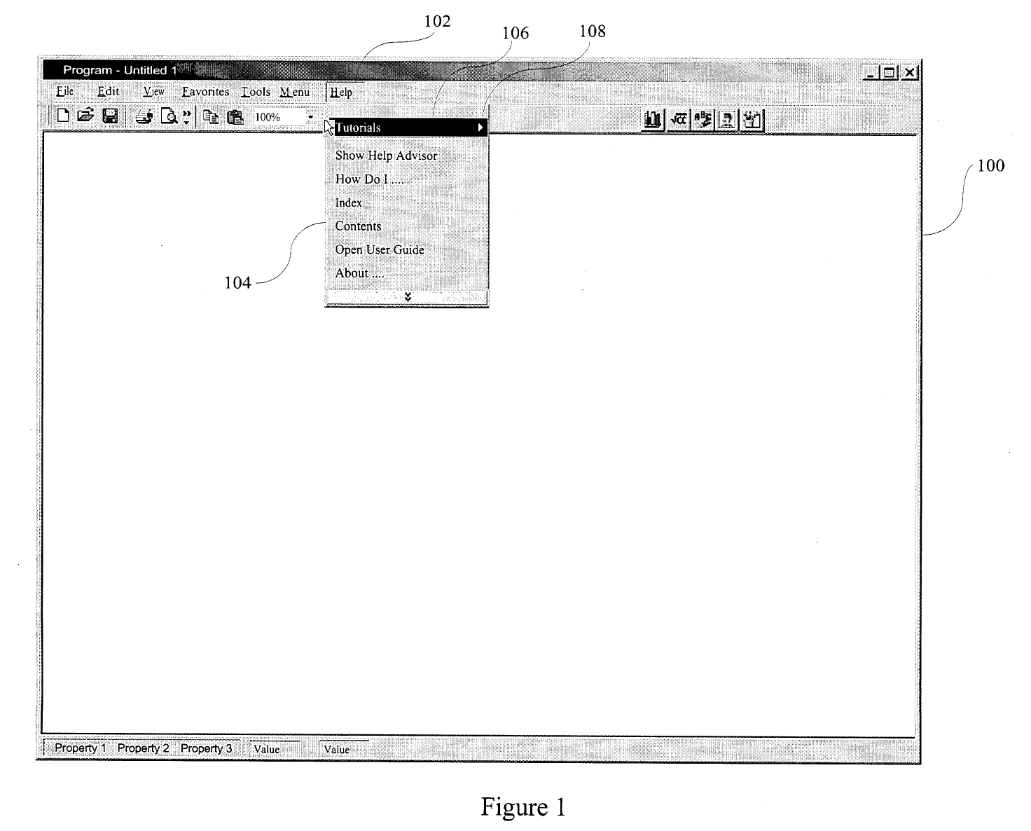

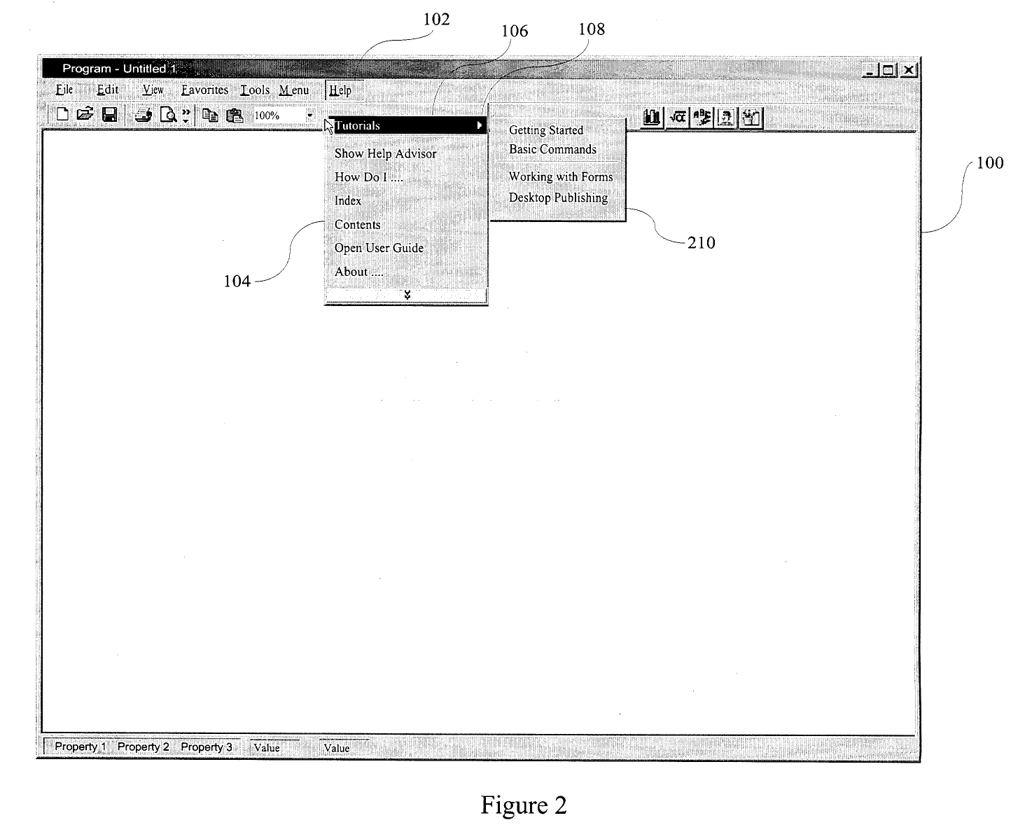

At step 510, a determination is made as to whether or not the menu selection made by the user invokes a cascading menu. In the example illustrated in FIGS. 1-4 of the present invention, the selection “tutorials” invokes a cascading menu, as indicated by the right arrow 108 in the figures, while the remaining displayed menu selections do not invoke a cascading menu. If, at step 510, it is determined that the menu selection does not invoke a cascading menu, then the process proceeds to step 512, where the operation associated with the menu selection is performed in the usual manner.

If at step 510, it is determined that the menu selection does invoke a cascading menu, then at step 514, the GUI identifies the offset value selected by the user for displaying cascading menus, and then the cascading menu is displayed pursuant to the obtained value. Thus, for example, if the user had selected the 20% offset option, then the cascading menu would be displayed approximately as shown in FIG. 3, that is, covering 80% of the parent menu 104 in the horizontal direction.

At step 516, the user selects a selection from the displayed cascading menu in the known manner, i.e., by highlighting the selection with a mouse pointer. The process then proceeds back to step 510 to determine if this menu selection invokes an additional cascading menu. As is well known, cascading menus can cascade down an essentially unlimited number of levels. If, at step 510, it is determined that an additional cascading menu is invoked based upon the menu selection, the process proceeds to step 514 and step 516. If, however, at step 510, it is determined that the menu selection does not invoke a cascading menu, the process proceeds to step 512 and the process terminates at step 518.

It will be understood that each element of the illustrations, and combinations of elements in the illustrations, can be implemented by general and/or special purpose hardware-based systems that perform the specified functions or steps, or by combinations of general and/or special-purpose hardware and computer instructions. The programming required to configure a GUI or any other software to perform the described functions is well within the capabilities of a programmer of ordinary skill in the art given the direction set forth above and shown in the drawings.

These program instructions maybe provided to a processor to produce a machine, such that the instructions that execute on the processor create means for implementing the functions specified in the illustrations. The computer program instructions may be executed by a processor to cause a series of operational steps to be performed by the processor to produce a computer-implemented process such that the instructions that execute on the processor provide steps for implementing the functions specified in the illustrations. Accordingly, FIGS. 3-5 support combinations of means for performing the specified functions, combinations of steps for performing the specified functions, and program instruction means for performing the specified functions.

The above-described steps can be implemented using standard well-known programming techniques. The novelty of the above-described embodiment lies not in the specific programming techniques but in the use of the steps described to achieve the described results. Software programming code which embodies the present invention is typically stored in permanent storage of some type, such as permanent storage of a workstation on which the GUI or other application is stored. In a client/server environment, such software programming code may be stored with storage associated with a server. The software programming code may be embodied on any of a variety of known media for use with a data processing system, such as a diskette, or hard drive, or CD-ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

While there has been described herein the principles of the invention, it is to be understood by those skilled in the art that this description is made only by way of example and not as a limitation to the scope of the invention. For example, although the above description is focused on the use of the present invention with a GUI installed on a PC, it is understood that it can function in any user interface in which a window display invokes an additional window display, including applications in PDA's, cell phones, and the like. In addition, while the above description focuses on movement of cascading menus in the horizontal direction, it is understood that the present invention also contemplates the display of cascading menus or cascading windows in any location on the screen, based upon the desires of the user, such as vertical movement, horizontal movement, or combined vertical and horizontal movement, so that the menu/window can be displayed anywhere on the viewing surface. It is intended by the appended claims, to cover all modifications of the invention which fall within the true spirit and scope of the invention.

1. A method of enabling user-control of the location of cascading menus invoked by
a parent menu in a Graphical User Interface (GUI), comprising the steps of:
determining if a parent menu invokes a cascading menu;
if said parent menu invokes a cascading menu, obtaining an offset value selection for said cascading menu; and
displaying said cascading menu in accordance with said obtained offset value selection.

2. The method as set forth in claim 1, further comprising the steps of:
soliciting from a user of said GUI a desired offset value for said cascading menus; and
storing said desired offset value as said offset value selection.

3. The method as set forth in claim 2, wherein said desired offset value selectable by said user can be any value from 0 to 100% offset.

4. The method as set forth in claim 2, wherein said desired offset value selectable by said user can be positive or negative.

5. A system for enabling user-control of the location of cascading menus invoked by a parent menu in a Graphical User Interface (GUI), comprising:
means for determining if a parent menu invokes a cascading menu;
means for obtaining an offset value selection for said cascading menu if said parent menu invokes a cascading menu; and
means for displaying said cascading menu in accordance with said obtained offset value selection.

6. The system as set forth in claim 5, further comprising:
means for soliciting from a user of said GUI a desired offset value for said cascading menus; and
means for storing said desired offset value as said offset value selection.

7. The system as set forth in claim 6, wherein said desired offset value selectable by said user can be any value from 0 to 100% offset.

8. The system as set forth in claim 6, wherein said desired offset value selectable by said user can be positive or negative.

9. A computer program product recorded on computer readable medium for enabling user-control of the location of cascading menus invoked by a parent menu in a Graphical User Interface (GUI), comprising:
computer readable means for determining if a parent menu invokes a cascading menu;
computer readable means for obtaining an offset value selection for said cascading menu if said parent menu invokes a cascading menu; and
computer readable means for displaying said cascading menu in accordance with said obtained offset value selection.

10. The computer program product as set forth in claim 9, further comprising:
computer readable means for soliciting from a user of said GUI a desired offset value for said cascading menus; and
computer readable means for storing said desired offset value as said offset value selection.

11. The computer program product as set forth in claim 10, wherein said desired offset value selectable by said user can be any value from 0 to 100% offset.

12. The computer program product as set forth in claim 10, wherein said desired offset value selectable by said user can be positive or negative.

13. A Graphical User Interface (GUI), comprising:
selection means for enabling a user of said GUI to specify an offset value for cascading menus;
determining means for determining if a selection from a parent menu invokes a cascading menu;
offsetting means for offsetting said cascading menu by said offset value if said determining means determines that said selection from said parent menu invokes a cascading menu.

14. The GUI of claim 13, wherein said selection means comprises a window that allows a user to input any percentage value as the selectable offset value.

15. The method of claim 14, wherein said offset value selector provides the user with a list of preset selectable offset values from which to choose the selectable offset value.

16. A method of reducing the amount of mouse movement required to access selections from a cascading menu invoked by a parent menu, comprising the steps of:
providing one or more selectable offset values for cascading menus, said one or more offset values each being less than 100%;
determining that a parent menu invokes a cascading menu;
displaying said cascading menu relative to said parent menu offset by one of said selectable offset values.

17. The method of claim 16, wherein said step of providing one or more selectable offset values comprises at least the steps of:
displaying to a user of said GUI an offset-value selector from which said user can select an offset value;
soliciting said user to select an offset value; and
using said selected offset value for offsetting any cascading menus invoked by said parent menu.

18. The method of claim 17, wherein said offset-value selector comprises a window that allows a user to input any percentage value from 0 to 100% as the selectable offset value.

19. The method of claim 17, wherein said offset value selector provides the user with a list of preset selectable offset values from which to choose the selectable offset value.
